(19) United States
(12) Patent Application Publication
(10) Pub. No.: US 2026/0148104 A1
(43) Pub. Date: May 28, 2026

(54) METHOD FOR DERIVING NEW RULE FOR DATA AUGMENTATION IN NATURAL LANGUAGE INFERENCE TASK AND SYSTEM THEREFOR

(71) Applicant: KNU-INDUSTRY COOPERATION FOUNDATION, Chuncheon-si (KR)

(72) Inventors: Chang Ki Lee, Seoul (KR); Ju Young Han, Seoul (KR); Hyun Sun Hwang, Goyang-si (KR); Young Jun Jung, Chuncheon-si (KR); Hyo Rim Choi, Chuncheon-si (KR)

(73) Assignee: KNU-INDUSTRY COOPERATION FOUNDATION, Chuncheon-si (KR)

(21) Appl. No.: 19/395,466

(22) Filed: Nov. 20, 2025

(30) Foreign Application Priority Data
Nov. 27, 2024 (KR) 10-2024-0171920

(51) Int. Cl. G06N 5/025; G06F 18/21; G06F 18/23; G06N 3/0475; G06N 5/04

(52) U.S. Cl. CPC G06N 5/025; G06F 18/217; G06F 18/23; G06N 3/0475; G06N 5/04

(57) ABSTRACT

A method and system are provided for deriving a new rule for data augmentation in a natural language inference task. The method for deriving a new rule according to some embodiments may include acquiring a base dataset for a natural language inference task, acquiring a rule detection model that detects an existing rule conforming to a premise-hypothesis sentence pair input from an existing rule set, and selecting a plurality of premise-hypothesis sentence pairs that does not conform to the existing rule set from the base dataset by performing out-of-distribution (OOD) detection based on the rule detection model on the base dataset. In this case, the selected premise-hypothesis sentence pairs may be used to derive the new rule set, and a high-quality augmented dataset for the natural language inference task can be easily generated through this new rule set.

### CROSS-REFERENCE TO RELATED APPLICATIONS

This application claims the priority of Korean Patent Application No. 10-2024-0171920 filed on Nov. 27, 2024, in the Korean Intellectual Property Office, the disclosure of which is incorporated herein by reference.

### BACKGROUND

### Field

The present disclosure relates to a technique for deriving a new sentence transformation rule to augment data (for example, a premise-hypothesis sentence pair) for a natural language inference task in various ways.

### Description of the Related Art

A natural language inference (NLI) is a core task in the field of natural language processing (NLP), and involves understanding a logical relationship between a premise sentence and a hypothesis sentence and categorizing the logical relationship as entailment, contradiction, or neutral. The natural language inference may serve as a core foundational technology in various natural language processing applications, such as question answering, document summarization, and machine reading comprehension.

However, in order to construct a new natural language inference model in a specific domain, a new dataset (that is, a training set) for that domain should be constructed, which takes a significant amount of time and cost. To address this issue, a data augmentation method has been proposed that automatically generates datasets by transforming the premise sentence into the hypothesis sentence a number using small of sentence transformation rules. However, these few sentence transformation rules alone cannot sufficiently reflect the diversity of actual premise-hypothesis sentence pairs, and therefore, the performance of the natural language inference model constructed using the proposed method is bound to be lower than that of existing domain-specific models.

### SUMMARY

An object of one embodiment of the present disclosure is to provide a method for deriving a new rule for data augmentation in a natural language inference task and a system therefor.

Specifically, another object of one embodiment of the present disclosure is to provide a method for deriving a new rule for data augmentation in a natural language inference task, and a system therefor capable of encompassing the diversity of premise-hypothesis sentence pairs.

In addition, still another object of one embodiment of the present disclosure is to provide a method and system capable of accurately generating a hypothesis sentence corresponding to a premise sentence using a new rule set.

Objects of the present disclosure are not limited to the above-described objects, and other objects not mentioned will be clearly understood by those skilled in the art of the present disclosure from the description below.

In order to achieve to the above-described objects, according to some embodiments of the present disclosure, there is provided a method for deriving a new rule for data augmentation in a natural language inference task and performed by at least one processor, the method including: acquiring a base dataset for a natural language inference task, the base dataset including sentence pairs composed of a premise sentence and a hypothesis sentence, and a label assigned to each of the sentence pairs, the label representing a class according to a logical relationship between the premise sentence and the hypothesis sentence; acquiring a rule detection model that detects an existing rule conforming to a premise-hypothesis sentence pair input from an existing rule set, the existing rule set including one or more existing rules that transform a given premise sentence into a hypothesis sentence; and selecting a plurality of premise-hypothesis sentence pairs that does not conform to the existing rule set from the base dataset by performing out-of-distribution (OOD) detection based on the rule detection model on the base dataset. In this case, the selected premise-hypothesis sentence pairs are used to derive a new rule set for generating an augmented dataset for the natural language inference task.

In some embodiments, the base dataset may belong to a source domain, the augmented dataset may belong to a target domain, and the target domain may be a domain with a smaller amount of natural language inference datasets than the source domain.

In some embodiments, the rule detection model may be constructed by fine-tuning a pretrained language model using a task of detecting the existing rule.

In some e embodiments, a training process of the rule detection model may include obtaining a plurality of original premise sentences, generating hypothesis sentences corresponding to the plurality of original premise sentences using the existing rule set and setting the existing rule used in the generation process as a label to generate a training set, and training the rule detection model by performing a task of detecting the existing rules using the training set.

In some embodiments, the rule detection model may be configured to output a probability distribution for the existing rule set, the selecting of the plurality of premise-hypothesis sentence pairs may include selecting a specific premise-hypothesis sentence pair from the base dataset, calculating an OOD score for the specific premise-hypothesis sentence pair based on output of the rule detection model for the specific premise-hypothesis sentence pair, and determining the specific premise-hypothesis sentence pair as the sentence pair that does not conform to the existing rule set when the OOD score is equal to or less than a threshold.

In some embodiments, the OOD score may be calculated based on a maximum probability value output by the rule detection model.

In some embodiments, the probability distribution may be calculated by applying a softmax operation to a raw output value of the rule detection model, and the calculating of the OOD score may include correcting the probability distribution by adjusting a scale of the raw output value according to a preset temperature parameter value, and calculating the OOD score based on the corrected probability distribution.

In some embodiments, the calculating of the OOD score may include applying perturbation to increase the maximum probability value of the rule detection model to a value associated with the specific premise-hypothesis sentence pair, and calculating the OOD score based on an output probability distribution of the rule detection model to which the perturbation is applied.

In some embodiments, the rule detection model may be configured to receive an embedding vector of each token included in the premise-hypothesis sentence pair, and the perturbation may be applied to at least some of the embedding vectors of a plurality of tokens included in the specific premise-hypothesis sentence pair.

In some embodiments, the selecting of the plurality of premise-hypothesis sentence pairs may include selecting candidate premise-hypothesis sentence pairs that do not conform to the existing rule set from the base dataset through the OOD detection, constructing a plurality of clusters through clustering of the candidate premise-hypothesis sentence pairs, and excluding some clusters of the plurality of clusters according to a preset filtering criterion to select the plurality of premise-hypothesis sentence pairs.

In some embodiments, the excluding of some clusters may include calculating a cohesion of each of the plurality of clusters, and excluding clusters among the plurality of clusters whose cohesion is less than a threshold.

In some embodiments, the excluding of some clusters may include calculating inconsistency of the label in each of the plurality of clusters, and excluding clusters among the plurality of clusters whose inconsistency is equal to or more than the threshold.

In some embodiments, the method for deriving a new rule may further include: acquiring the new rule set and a plurality of original premise sentences; and applying the new rule set to a generative language model to generate hypothesis sentences corresponding to the plurality of original premise sentences, thereby generating the augmented dataset.

In order to achieve to the above-described objects, according to some embodiments of the present disclosure, there is provided a system for deriving a new rule for data augmentation in a natural language inference task, the system including: one or more processors; and a memory storing a computer program executed by the one or more processors, in which the computer program includes instructions for an operation of acquiring a base dataset for a natural language inference task, the base dataset including sentence pairs composed of a premise sentence and a hypothesis sentence, and a label assigned to each of the sentence pairs, the label representing a class according to a logical relationship between the premise sentence and the hypothesis sentence, an operation of acquiring a rule detection model that detects an existing rule conforming to a premise-hypothesis sentence pair input from an existing rule set, the existing rule set including one or more existing rules that transform a given premise sentence into a hypothesis sentence, and an operation of selecting a plurality of premise-hypothesis sentence pairs that does not conform to the existing rule set from the base dataset by performing out-of-distribution (OOD) detection based on the rule detection model on the base dataset. In this case, the selected premise-hypothesis sentence pairs are used to derive a new rule set for generating an augmented dataset for the natural language inference task.

In order to achieve to the above-described objects, according to some embodiments of the present disclosure, there is provided a computer program combined with a processor of a computer and stored in a computer-readable recording medium to execute: acquiring a base dataset for a natural language inference task, the base dataset including sentence pairs composed of a premise sentence and a hypothesis sentence, and a label assigned to each of the sentence pairs, the label representing a class according to a logical relationship between the premise sentence and the hypothesis sentence; acquiring a rule detection model that detects an existing rule conforming to a premise-hypothesis sentence pair input from an existing rule set, the existing rule set including one or more existing rules that transform a given premise sentence into a hypothesis sentence; and selecting a plurality of premise-hypothesis sentence pairs that does not conform to the existing rule set from the base dataset by performing out-of-distribution (OOD) detection based on the rule detection model on the base dataset. In this case, the selected premise-hypothesis sentence pairs are used to derive a new rule set for generating an augmented dataset for the natural language inference task.

According to some embodiments of the present disclosure, a rule detection model is constructed that detects the existing rule conforming to the premise-hypothesis sentence pair input from the existing rule set, and by performing the out-of-distribution (OOD) detection based on this rule detection model, the premise-hypothesis sentence pairs that do not conform to the existing rule set can be accurately selected from the base dataset for the natural language inference task. Furthermore, a new rule set that encompasses the diversity of premise-hypothesis sentence pairs not covered by the existing rule set can be accurately derived from these selected premise-hypothesis sentence pairs, and as a result, a high-quality augmented dataset for a natural language inference task can be easily and automatically generated.

In addition, the OOD score can be accurately calculated based on the maximum probability value output by the rule detection model, the corrected probability distribution according to the value of the temperature parameter, the adjusted probability distribution according to perturbation, or the like, and as a result, premise-hypothesis sentence pairs that do not conform to the existing rule set in the base dataset can be more accurately selected.

Additionally, by performing cluster-based filtering based on cohesion and label inconsistency, the premise-hypothesis sentence pairs that do not conform to the existing rule set in the base dataset can be more accurately selected.

Furthermore, by applying the new rule to the generative language models, the hypothesis sentence corresponding to the original premise sentence can be accurately generated, and as a result, a high-quality augmented dataset for the natural language inference task can be more easily automatically generated.

Effects according to the technical idea of the present disclosure are not limited to the effects mentioned above, and other effects not mentioned will be clearly understood by those skilled in the art from the description below.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exemplary diagram for explaining the operation of a rule derivation system according to some embodiments of the present disclosure at the system level.

FIG. 2 is an exemplary diagram for further explaining the operation of the rule derivation system according to some embodiments of the present disclosure.

FIG. 3 is an exemplary flowchart illustrating a method for deriving a new rule for data augmentation in a natural language inference task according to some embodiments of the present disclosure.

FIG. 4 is an exemplary diagram illustrating a method for training a rule detection model according to some embodiments of the present disclosure.

FIG. 5 is an exemplary flowchart illustrating a detailed process of the premise-hypothesis sentence pair selection step illustrated in FIG. 3.

FIG. 6 is an exemplary diagram illustrating a method of calculating an out-of-distribution (OOD) score according to some embodiments of the present disclosure.

FIG. 7 is an exemplary diagram illustrating the method for calculating the OOD score according to some other embodiments of the present disclosure.

FIGS. 8 and 9 are exemplary diagrams illustrating the method for calculating the OOD score according to some other embodiments of the present disclosure.

FIG. 10 is an exemplary diagram illustrating a method for clustering a candidate premise-hypothesis sentence pair according to some embodiments of the present disclosure.

FIG. 11 is an exemplary diagram illustrating a cluster-based filtering method according to some embodiments of the present disclosure.

FIG. 12 illustrates an exemplary computing device capable of implementing a rule derivation to some system according embodiments of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, various embodiments of the present disclosure will be described in detail with reference to the attached drawings. The advantages and features of the present disclosure, and methods for achieving them, will become clear with reference to the embodiments described in detail below together with the attached drawings. However, the technical idea of the present disclosure is not limited to the following embodiments and may be implemented in various different forms. The following embodiments are provided only to complete the technical idea of the present disclosure and to fully inform those skilled in the art of the present disclosure of the scope of the present disclosure, and the technical idea of the present disclosure is defined only by the scope of the claims.

In describing various embodiments of the present disclosure, when it is determined that a detailed description of a related known configuration or function may obscure the gist of the present disclosure, the detailed description will be omitted.

Unless otherwise defined, the terms (including technical and scientific terms) used in the following embodiments may be used with meanings commonly understood by those of ordinary skill in the art to which this disclosure pertains. However, this may vary depending on the intentions of engineers working in the relevant field, precedents, the emergence of new technologies, or the like. The terminology used in this disclosure is for the purpose of describing the embodiments and is not intended to limit the scope of this disclosure.

In the following embodiments, singular expressions include plural concepts unless the context clearly specifies that they are singular. Furthermore, plural expressions include singular concepts unless the context clearly specifies that they are plural.

In addition, terms such as first, second, A, B, (a), (b), or the like used in the following embodiments are only used to distinguish certain components from other components, and the nature, order, or sequence of the components is not limited by the terms.

The components described with reference to terms such as unit, module, block, ˜or, ˜er used in the embodiments below and the functional blocks illustrated in the drawings may be implemented in the form of software, hardware, or a combination thereof. The software may be, for example, machine code, firmware, embedded code, and application software. In addition, the hardware may include, for example, electric circuits, electronic circuits, processors, computers, integrated circuits, integrated circuit cores, passive components, or a combination thereof.

Hereinafter, various embodiments of the present disclosure will be described in detail with reference to the attached drawings.

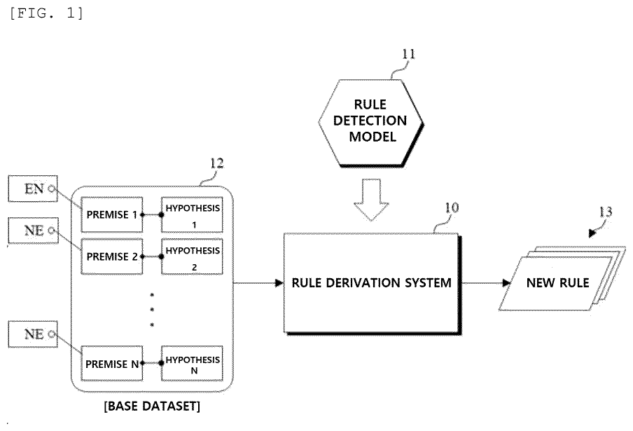

FIG. 1 is an exemplary diagram for explaining the operation of a rule derivation system 10 according to some embodiments of the present disclosure at the system level. In the drawings below FIG. 1, “EN”, “CO”, and “NE” indicated in the labels of premise-hypothesis sentence pairs represent classes according to the logical relationship of the corresponding premise-hypothesis sentence pairs, and “EN”, “CO”, and “NE” represent entailment, contradiction, and neutral, respectively.

As illustrated in FIG. 1, the rule derivation system 10 is a computing device/system capable of deriving a new rule set 13 used for data augmentation of a natural language inference (NLI) task. For example, the rule derivation system 10 may select a plurality of premise-hypothesis sentence pairs used for deriving the new rule set 13 from a base dataset 12 regarding the natural language inference task, and may also derive the new rule set 13 by analyzing these premise-hypothesis sentence pairs. In this case, the base dataset 12 is obtained from a source domain with an abundant amount of natural language inference datasets, and the augmented dataset (not illustrated) generated by the new rule set 13 may be a dataset to be utilized in the target domain (for example, a domain with a small/insufficient amount of natural language inference datasets compared to the source domain), but the scope of the present disclosure is not limited thereto. The augmented dataset may be used, for example, as a training set for constructing the new natural language inference model (or model related to the natural language inference task) in the target domain.

The rule derivation system 10 may, in some cases, be named as a “new rule derivation system”.

The base dataset 12 is a dataset (that is, a natural language inference dataset) of a natural language inference task that serves as the basis for data augmentation, and may be configured to include a plurality (various) of sentence pairs consisting of premise sentences and hypothesis sentences, and labels assigned to each of the sentence pairs. As described above, the labels classes to represent according the logical relationships between the premise sentences and hypothesis sentences. Such classes may be defined as, for example, entailment, contradiction, and neutral, but the scope of the present disclosure is not limited thereto. In some cases, the base dataset 12 may further include an explanatory sentence related to the logical relationships. For specific examples of the premise-hypothesis sentence pair, please refer to Table 2.

For reference, the premise sentence may be named as a “premise sentence sample” or “premise sample” depending on the case, and the hypothesis sentence may also be named as a “hypothesis sentence sample” or “hypothesis sample” depending on the case.

The new rule set 13 is a set of new rules (more precisely, new sentence transformation rules) that do not exist in the predefined existing rule set, and may include one or more new rules. Here, both the existing rules and the new rules refer to rules that transform the premise sentence into the hypothetical sentence with a specific class of logical relationships. These rules may also be named, as appropriate, “transformation/augmentation rules” or “sentence transformation/augmentation rules”. For specific examples of the existing rules, refer to Table 1.

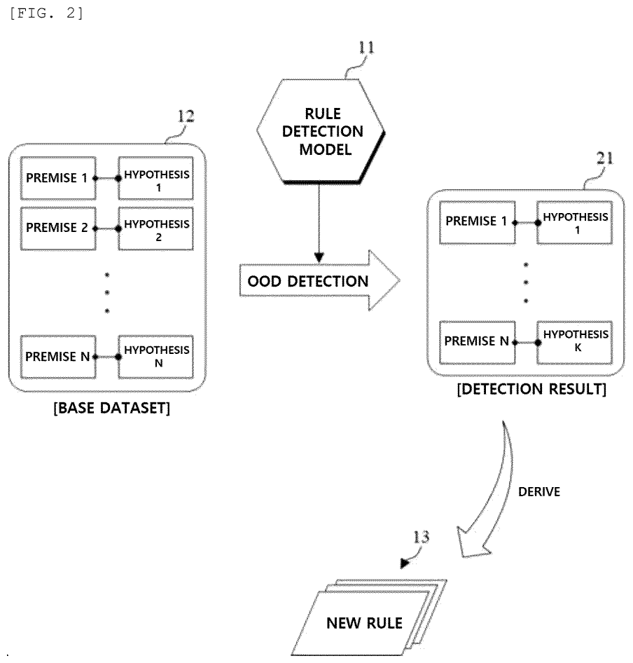

FIG. 2 is an exemplary diagram for further explaining the operation of the rule derivation system 10 according to some embodiments of the present disclosure. In FIG. 2, the illustration of the labels of the base dataset 12 is omitted.

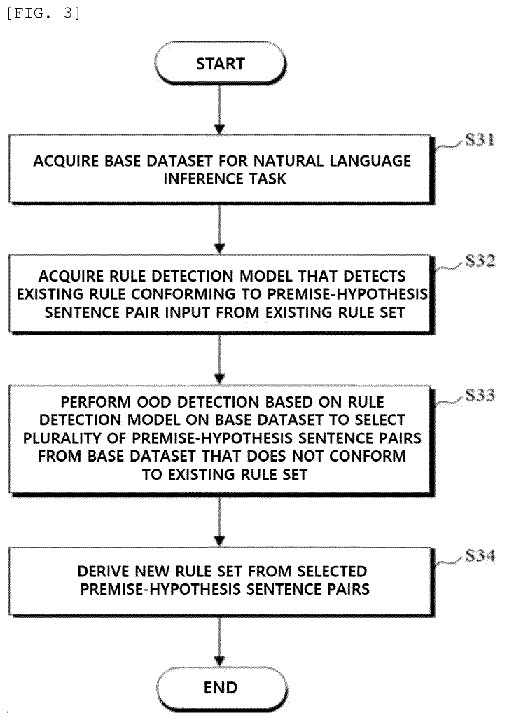

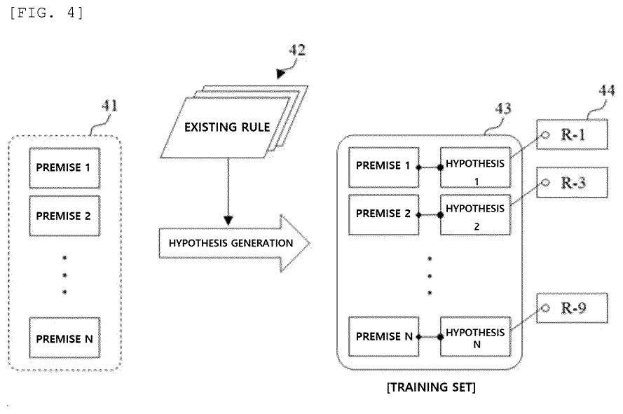

As illustrated in FIG. 2, the rule derivation system 10 may select (extract) a plurality of premise-hypothesis sentence pairs 21 that do not conform to an existing rule set by performing out-of-distribution (OOD) detection based on the rule detection model 11 on the base dataset 12. Here, the rule detection model 11 refers to a model that detects the existing rules conforming to the premise-hypothesis sentence pairs input from the existing rule set. A method for constructing the model 11 will be described later with reference to FIGS. 3 and 4, or the like.

The rule detection model 11 may be named as a “rule classification model”, “existing rule detection/classification model”, or the like in some cases.

Additionally, the rule derivation system 10 may also derive the new rule set 13 by analyzing the selected premise-hypothesis sentence pairs 21. The specific method for deriving the new rule set 13 may be any method.

In some cases, the rule derivation system 10 may generate the augmented dataset (not illustrated) for the natural language inference task by generating hypothesis sentences corresponding to pre-prepared original premise sentences using the new rule set 13. In this case, a high-quality augmented dataset may be generated that reflects the diversity of premise-hypothesis sentence pairs not covered by the existing rule sets.

The detailed operations of the rule derivation system 10 will be described in detail later with reference to the drawings below FIG. 3.

The above-described rule derivation system 10 may be implemented on at least one computing device. For example, all functions of the rule derivation system 10 may be implemented on a single computing device, or a first function of the rule derivation system 10 may be implemented on a first computing device and a second function may be implemented on a second computing device. Alternatively, specific functions of the rule derivation system 10 may be implemented on a plurality of computing devices.

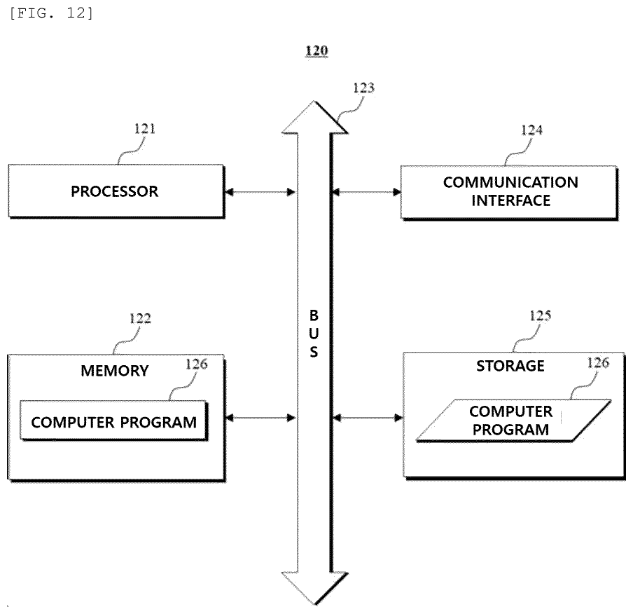

The computing device may include any device equipped with computing capabilities, and for an example of the device, refer to FIG. 12. The computing device is a collection of interacting components (for example, memory, processor, or the like), and the computing device may sometimes be referred to as a “computing system”. Of course, the term “computing system” may also encompass the concept of a collection of interacting a plurality of computing devices.

So far, the operation of the rule derivation system 10 according to some embodiments of the present disclosure has been briefly described with reference to FIGS. 1 and 2. Hereinafter, various methods that can be performed in the above-described rule derivation system 10 will be described with reference to the drawings including FIG. 3 and below.

Hereinafter, for ease of understanding, the explanation will proceed under the assumption that all steps/operations of the methods to be described below are performed by the rule derivation system (10, for example, at least one processor) described above. Therefore, when the subject of a specific step/operation is omitted, it can be understood that the step/operation is performed by the rule derivation system 10. However, in an actual environment, some steps/operations of the methods to be described below may be performed on other computing devices. For example, the construction (training) of the rule detection model 11 may be performed on other computing devices/systems.

Hereinafter, for convenience of explanation, the rule derivation system 10 is abbreviated as a “system”.

FIG. 3 is an exemplary flowchart illustrating a method for deriving the new rule according to some embodiments of the present disclosure. However, this is merely an exemplary embodiment for achieving the objectives of the present disclosure, and it is understood that some steps may be added or deleted as needed.

As illustrated in FIG. 3, the method for deriving the new rule according to embodiments may begin with Step S31, which involves acquiring the base dataset for the natural language inference task. As described above, the base dataset may include a number of premise-hypothesis sentence pairs and labels indicating classes based on their logical relationships, and may be used to derive the new rule set. In some cases, the base dataset may further include the explanatory sentences related to the logical relationships between the premise-hypothesis sentence pairs.

In Step S32, the rule detection model 11 is acquired that detects the existing rule conforming to the premise-hypothesis sentence pair input from the existing rule set. Here, the rule detection model 11 may be a model configured to receive the premise-hypothesis sentence pair and output a probability distribution (that is, a probability value for each existing rule) for the existing rule set. This rule detection model 11 may be constructed, for example, by connecting a classification layer (head) for rule detection to a pretrained language model (for example, bidirectional encoder representations from transformer (BERT), or the like) and fine-tuning the language model through an existing rule detection task. However, the scope of the present disclosure is not limited thereto.

As a more specific example, as illustrated in FIG. 4, the system 10 may construct (train) the rule detection model 11 using an augmented dataset 43 generated using an existing rule set 42. Specifically, the system 10 may generate hypothesis sentences corresponding to a plurality of original premise sentences (41, for example, premise sentences selected from a base dataset, or the like) using the existing rule set 42, and generate (construct) a training set 43 by setting an existing rule (for example, “R-1” reference) used in this generation process as a label (for example, 44 reference) for pairs of original premise sentences and hypothesis sentences. For example, the system 10 may construct a prompt based on the original premise sentence, the existing rule, examples of generating hypothesis sentences using the existing rule and/or similar existing rules thereof (for example, incorrect examples, correct examples, or the like), and input the prompt into a generative language model to generate the hypothesis sentence corresponding to the original premise sentence. However, the scope of the present disclosure is not limited thereto. Next, the system 10 may train (construct) the rule detection model 11 by performing an existing rule detection task based on supervised learning using the training set 43 (for example, updating the parameters of the rule detection model 11 based on the classification loss according to the detection result). This training process may correspond to a fine-tuning process, but the scope of the present disclosure is not limited thereto.

This is explained again with reference to FIG. 3.

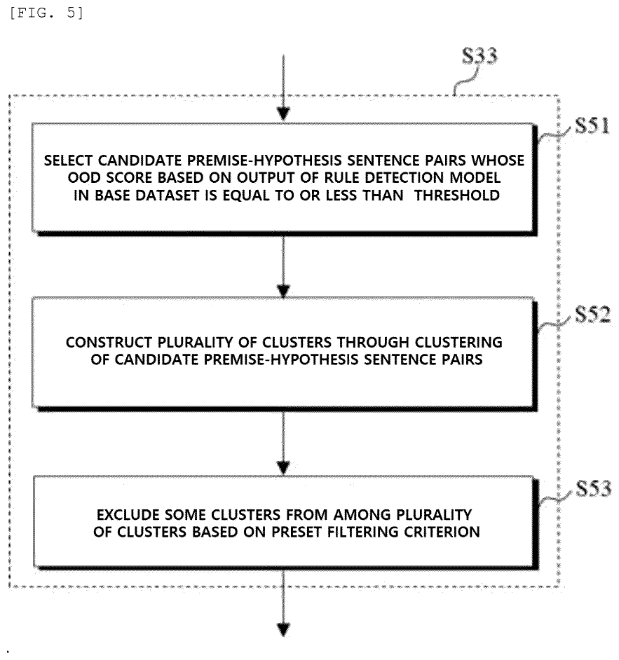

In Step S33, the OOD detection based on the rule detection model is performed on the base dataset, thereby selecting a plurality of premise-hypothesis sentence pairs from the base dataset that do not conform to the existing rule set. The detailed process of this Step S33 is illustrated in FIG. 5.

FIG. 5 is an exemplary flowchart illustrating the detailed process of Step S33. However, this is merely an exemplary embodiment for achieving the purpose of the present disclosure, and it is to be understood that some steps may be added or deleted as needed.

As illustrated in FIG. 5, first, candidate premise-hypothesis sentence pairs (that is, candidate premise-hypothesis sentence pairs that do not conform to the existing rule set) whose OOD score based on the output of the rule detection model 11 in the base dataset is equal to or less than a threshold are selected (S51). However, the specific OOD score calculation method (or OOD detection method) may vary depending on the embodiment.

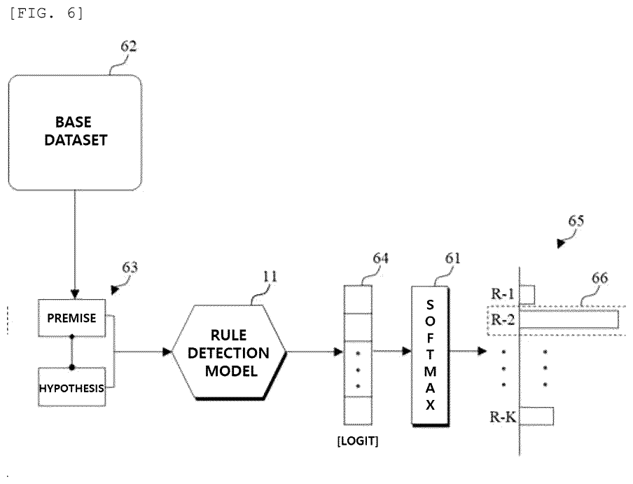

In some embodiments, the OOD score may be calculated based on the maximum probability value output by the rule detection model 11. For example, as illustrated in FIG. 6, let us assume that the rule detection model 11 transforms the raw output value (64, so-called “logit”) into a probability distribution for K existing rules (where K is a natural number greater than or equal to 1) through a softmax operation 61 (or layer) and outputs the result. In this case, the system 10 may select a premise-hypothesis sentence pair 63 from the base dataset 62 and input the premise-hypothesis sentence pair 63 into the rule detection model 11 to obtain a probability distribution 65 for the existing rules. Next, the system 10 calculates the OOD score of the premise-hypothesis sentence pair 63 based on the maximum probability value 66 in the probability distribution 65 (for example, calculates the OOD score as a proportional value), and when the OOD score is equal to or less than a threshold, it may be determined that the premise-hypothesis sentence pair 63 corresponds to OOD (that is, it is determined that the sentence pair does not conform to the existing rule set). In other words, the system 10 may determine that the premise-hypothesis sentence pair 63 corresponds to the OOD when the maximum probability value 66 is lower than the threshold. This is because a low maximum probability value 66 means that the certainty of the rule detection model 11 for the premise-hypothesis sentence pair 63 is low, which means that the premise-hypothesis sentence pair 63 is likely to correspond to the OOD. The system may repeat this process for other premise-hypothesis sentence pairs of the base dataset 62.

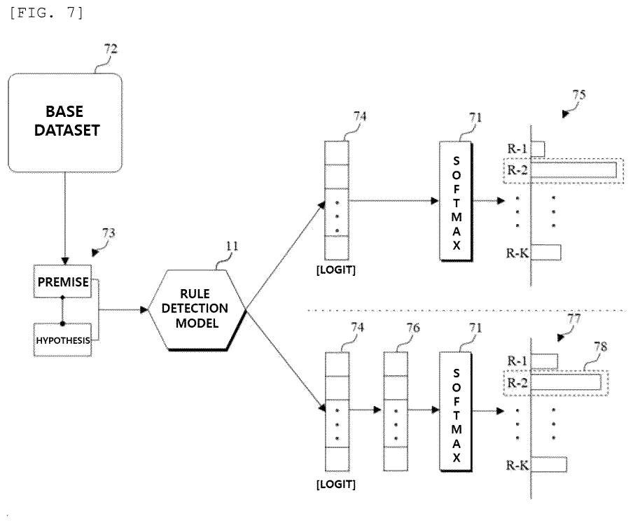

In some other embodiments, the raw output (that is, logit) of the rule detection model 11 may be adjusted (scaled) based on a preset temperature parameter (or scale parameter), and the OOD score may be calculated based on a probability distribution (that is, a corrected probability distribution) of the existing rule set obtained from the adjusted raw output. For example, as illustrated in FIG. 7, the system 10 may input the premise-hypothesis sentence pair 73 selected from the base dataset 72 into the rule detection model 11 to produce a raw output value 74, and may obtain a corrected probability distribution 77 for the existing rule set by adjusting the scale of the raw output value 74 according to the value of the temperature parameter. For example, the system 10 may set the value of the temperature parameter to a value greater than 1, and may adjust the scale of the raw output value 74 according to the following Mathematical Expression 1. In this case, since the probability distribution 77 is corrected (calibrated) to be flatter than original probability the distribution 75, the effect of controlling the overconfidence of the rule detection model 11 may be achieved, and as a result, the accuracy of OOD detection may be improved. Then, the system 10 may calculate the OOD score based on the corrected probability distribution 77 for the existing rule set. For example, the system may calculate the OOD score based on the maximum probability value 78 in the corrected probability distribution 77, and when this OOD score is equal to or less than the threshold, it may be determined that the premise-hypothesis sentence pair 73 corresponds to the OOD.

$${S}_{i} ( x ; T ) = \frac{exp ( {f}_{i} ( x ) / T )}{{\sum }_{j = 1}^{N} exp ( {f}_{j} ( x ) / T )} \qquad [ Mathematical Expression 1 ]$$

In Mathematical Expression 1, Si represents the probability value of the ith existing rule for the premise-hypothesis sentence pair (x), fᵢ(x) represents the raw output value for the ith existing rule, and T represents the temperature parameter. In addition, N represents the number of existing rules.

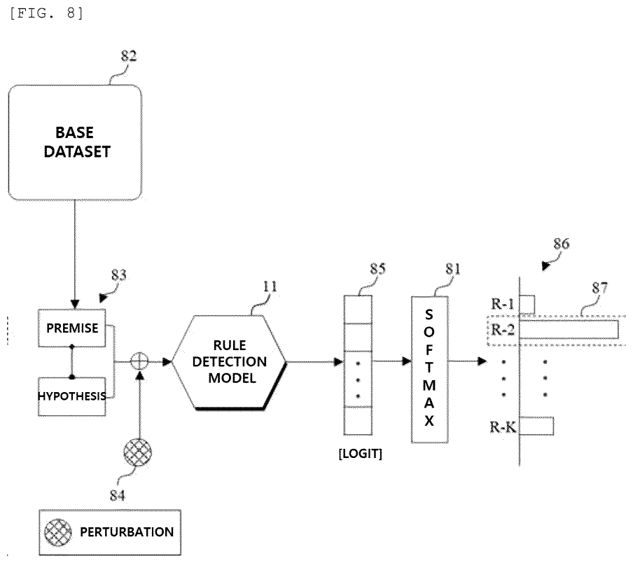

In some other embodiments, the probability distribution for the existing rule set output by the rule detection model 11 may be adjusted by applying perturbation (or noise) to the value associated with the premise-hypothesis sentence pair, and the OOD score may be calculated based on the adjusted probability distribution. For example, as illustrated in FIG. 8, the system may adjust output probability distribution 86 of the rule detection model 11 by applying perturbation 84 to a value (for example, an embedding vector, or the like) associated with a premise-hypothesis sentence pair 83 selected from a base dataset 82 to increase the maximum probability value 87 of the rule detection model 11. The following Mathematical Expression 2 expresses this process as a formula. For reference, the reason for applying the perturbation 84 that increases the maximum probability value 87 may be understood as because the perturbation 84 tends to increase the maximum probability value of the in-distribution (ID) to a greater extent than the OOD. As described above, the probability distribution 86 may be calculated by applying the softmax operation 81 to the raw output value 85. Then, the system 10 calculates the OOD score based on the adjusted probability distribution 86 (for example, calculates the OOD score based on the maximum probability value 87), and when this OOD score is equal to or less than the threshold, it may be determined that the premise-hypothesis sentence pair 83 corresponds to the OOD.

$$\tilde{x} = x - εsign ( - {∇}_{x} {log S}_{\hat{y}} ( x ; T ) ) \qquad [ Mathematical Expression 2 ]$$

In Mathematical Expression 2, \tilde{x} denotes value adjusted by perturbation (ε), and X denotes a value related to the premise-hypothesis sentence pair. In addition, the sign denotes a sign that determines the direction of change due to perturbation (ε), the symbol ∇ₓ denotes a gradient with respect to x, and the term related to S denotes the maximum probability value with respect to x. In addition, T denotes a temperature parameter that controls the degree of smoothing of the softmax operation.

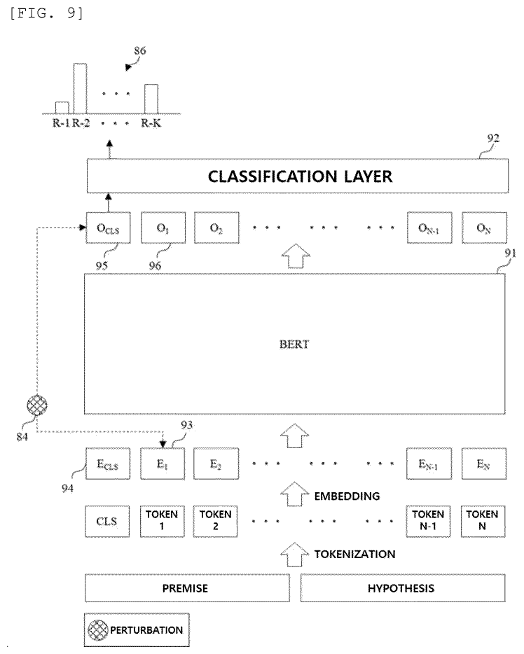

In the preceding embodiments, the perturbation 84 may be applied, for example, to a token (word) embedding and/or sentence embedding of the premise-hypothesis sentence pair 83. For example, as illustrated in FIG. 9, it is assumed that the rule detection model 11 is composed of BERT 91 (that is, a BERT encoder) and a classification layer 92. Here, the classification layer 92 may be, for example, a neural network layer (for example, a fully-connected layer) configured to output the probability distribution 86 for the existing rule set based on an output embedding vector 95 of a CLS token. In this case, the system 10 may apply the perturbation 84 to the embedding vector (for example, 93) of the token constituting the premise-hypothesis sentence pair 83, the embedding vector (for example, 94) of the CLS token, the output embedding vector (for example, 96) of the corresponding token, and/or the output embedding vector 95 (that is, sentence embedding vector) of CLS token. According to the experimental results of the inventors of the present disclosure, the OOD detection accuracy is found to be the best when the perturbation 84 is applied to the token embedding vector (for example, 93).

In some other embodiments, the OOD score may be calculated based on the entropy value of the probability distribution of the existing rule set output by the rule detection model 11. For example, the system 10 may calculate the OOD score based on the entropy value of a specific premise-hypothesis sentence pair (for example, calculate the OOD score as an inversely proportional value), and when the OOD score is equal to or less than the threshold, the premise-hypothesis sentence pair may be determined to be OOD.

In some other embodiments, the OOD detection may be performed based on various combinations of the above-described embodiments. For example, the system 10 may calculate a first OOD score, a second OOD score, and a third OOD score according to each of the embodiments illustrated in FIGS. 6 to 8, and may sum (for example, weighted sum) the calculated OOD scores to calculate a final OOD score for a specific premise-hypothesis sentence pair. Then, the system 10 may determine that the premise-hypothesis sentence pair corresponds to the OOD when the final OOD score is equal to or less than the threshold.

This is explained again with reference to FIG. 5.

Steps S52 and S53, which will be described later, may be understood as being performed to more accurately select the premise-hypothesis sentence pairs that do not conform to the existing rule set, and may be omitted in some cases.

In Step S52, a plurality of clusters is constructed through clustering of the candidate premise-hypothesis sentence pairs. For example, the system 10 may perform clustering on the candidate premise-hypothesis sentence pairs in the embedding space using a clustering technique such as the K-means clustering algorithm. However, the specific clustering method may vary depending on the embodiment.

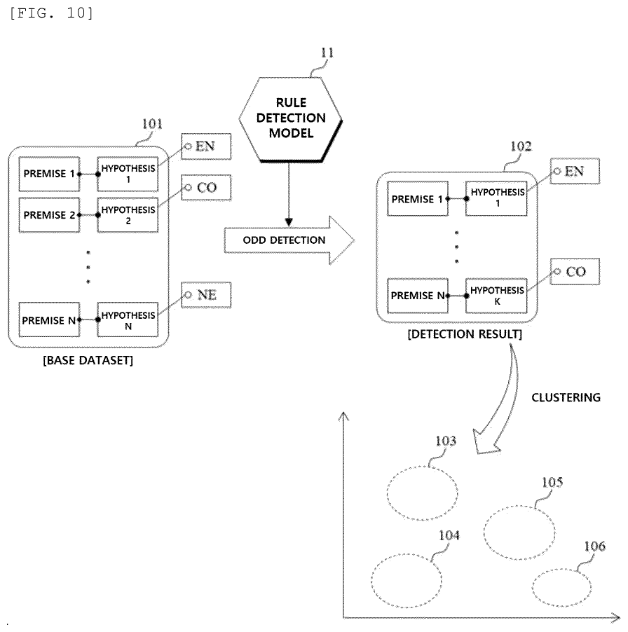

In some embodiments, clustering may be performed on the candidate premise-hypothesis sentence pairs. For example, as illustrated in FIG. 10, let us assume that the OOD detection based on the rule detection model 11 is performed on a base dataset 101 to select K (where K is a natural number less than N) candidate premise-hypothesis sentence pairs 102. In this case, the system may embed each of the candidate premise-hypothesis sentence pairs 102 through a natural language embedding model (not illustrated, for example, BERT) to generate a plurality of embedding vectors (for example, BERT output embedding vectors corresponding to CLS tokens). Then, the system 10 may cluster the corresponding embedding vectors to construct a plurality of clusters 103 to 106. FIG. 10 illustrates a case where the number of clusters is “4” as an example. A natural language embedding model may be a deep learning model equipped with embedding capabilities for natural language (or text), such as BERT. However, the scope of this disclosure is not limited thereto. The natural language embedding model may also be referred to as a “text embedding model” or “language model”, depending on the context.

In some other embodiments, clustering may be performed on the candidate premise-hypothesis sentence pairs and their explanatory sentences. For example, it is assumed that the base dataset includes, in addition to the premise-hypothesis sentence pairs, their explanatory sentences. In such a case, the system 10 may repeatedly embed specific candidate premise-hypothesis sentence pairs and their explanatory sentences using a natural language embedding model to generate the plurality of embedding vectors. The system 10 may then cluster the embedding vectors to construct a plurality of clusters.

In some other embodiments, clustering may be performed on the explanatory sentences of the candidate premise-hypothesis sentence pairs. For example, the system 10 may embed the explanatory sentences of each candidate premise-hypothesis sentence pair using the natural language embedding model to generate a plurality of embedding vectors. The system 10 may then cluster the embedding vectors to construct a plurality of clusters.

This is explained again with reference to FIG. 5.

In Step S53, a plurality of premise-hypothesis sentence pairs is selected by excluding some clusters from among the plurality of clusters based on a preset filtering criterion (conditions). That is, the system 10 excludes some clusters through cluster-based filtering and ultimately selects candidate premise-hypothesis sentence pairs belonging to the remaining clusters as sentence pairs to be used for deriving a new rule set. However, the specific filtering criterion/method may vary depending on the embodiment.

In some embodiments, some clusters may be excluded from a plurality of clusters based on their cohesion. For example, the system 10 may calculate the cohesion of each of the plurality of clusters and exclude clusters with a cohesion below a threshold. The cohesion of a cluster may be calculated based on the average Euclidean distance of instances (for example, embedding vectors of premise-hypothesis sentence pairs) belonging to the cluster, as in Mathematical Expression 3 below, but the scope of the present disclosure is not limited thereto.

$$Mean Pairwise Distance = \frac{2}{m ( m - 1 )} {\sum }_{i = 1}^{m - 1} {\sum }_{j = i + 1}^{m} d ( {x}_{i} , {x}_{j} ) \qquad [ Mathematical Expression 3 ]$$

In Mathematical Expression 3, m represents the number of instances in the cluster, d represents the Euclidean distance between two instances, and xᵢ and xⱼ represent the ith instance and the jth instance, respectively.

In some other embodiments, some clusters may be excluded from the plurality of clusters based on label inconsistency. For example, the system 10 may exclude clusters in which the label inconsistency (that the degree to which are is, classes inconsistent according to logical relationships) of instances (for example, embedding vectors of premise-hypothesis sentence pairs) belonging to each of the plurality of clusters is equal to or more than the threshold. For example, the system 10 may exclude clusters with mismatched labels from the plurality of clusters.

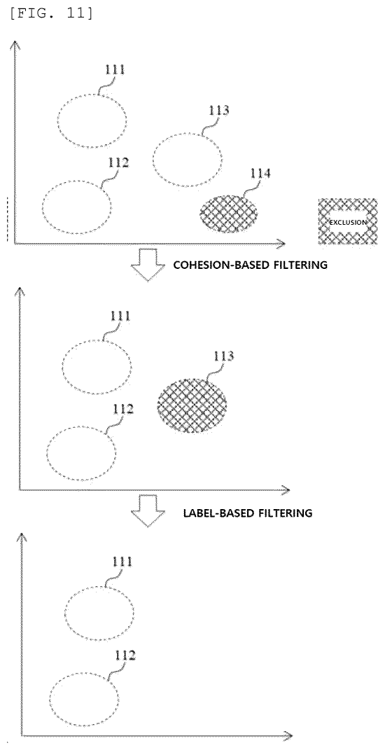

In some other embodiments, the premise-hypothesis sentence pair to be used for deriving the new rule set may be selected based on various combinations of the above-described embodiments. For example, as illustrated in FIG. 11, the system 10 may, among a plurality of clusters 111 to 114, exclude a cluster 114 having the cohesion less than a first threshold and a cluster 113 having a label inconsistency equal to or more than a second threshold, and finally select candidate premise-hypothesis sentence pairs of the remaining clusters 111 and 112 as the sentence pairs to be used for deriving the new rule set.

This is explained again with reference to FIG. 3.

In Step S34, the new rule set is derived from the selected premise-hypothesis sentence pairs. For example, the system 10 may receive the new rule set from a user. That is, the new rule set may be derived through an intervention of the user, and the system may receive the new rule set from the user. Alternatively, the system 10 may derive the new rule set by analyzing the differences between the selected premise-hypothesis sentence pairs. For example, the system 10 may compare the premise sentence and the hypothesis sentence to identify the difference, and derive information about the characteristic changes in the difference (for example, change in part of speech, change in meaning, change in structure, change in style, or the like) through natural language processing. Then, the system 10 may configure a prompt for deriving a new rule that transforms the premise sentence into the hypothesis sentence based on this characteristic change information, the text (phrase) of the difference, the premise-hypothesis sentence pair, examples of generating the hypothesis sentence using the existing rule, or the like. Next, the system may input the prompt into a generative language model to derive the new rule. For specific examples of the new rule, refer to Table 3.

In some embodiments, the system 10 may generate the augmented dataset for the natural language inference task by applying the new rule set to the generative language model to generate the hypothesis sentences corresponding to the plurality of original premise sentences. The original premise sentences may be collected from a target domain (for example, when performing data augmentation to construct the natural language inference model in the target domain) or selected from a base dataset. Specifically, the system 10 may generate a prompt including an original premise sentence and a directive (that is, directive requesting that the hypothesis sentence corresponding to the original premise sentence be generated) requesting that the original premise sentence be transformed into the hypothesis sentence according to the new rule, and inputs the prompt into the generative language model to generate the hypothesis sentence corresponding to the original premise sentence. The directive may be written as a sentence (phrase) that guides the generative language model to explain the process of transforming the original premise sentence into the hypothesis sentence according to the new rule step by step. In this case, the generative language model may generate the hypothesis sentence more accurately. Next, the system 10 may pair the original premise sentences with the generated hypothesis sentences, and label these sentence pairs with classes of logical relationships related to the new rules. The system 10 may then repeat these steps for other original premise sentences and other new rules in the new rule set, thereby generating the augmented dataset for the natural language inference task.

In some cases, the prompt may further include directives requesting the generation of an explanatory sentence related to the logical relationship between the original premise sentence and the hypothesis sentence. In such cases, the generative language model may generate both the hypothesis sentence and the explanatory sentence (that is, the response of the generative language model includes the explanatory sentence in addition to the hypothesis sentence).

Alternatively, the prompt may include additional examples (for example, incorrect examples, correct examples, or the like) of the hypothetical sentence generation using the new rule or a similar rule (for example, other new rules, existing rules, or the like). In such cases, the generative language model may generate the hypothetical sentences more accurately.

So far, a method for deriving the new rule for data augmentation in the natural language inference task has been described with reference to FIGS. 3 to 11. According to the foregoing, the rule detection model 11 is constructed to detect the existing rule conforming to the premise-hypothesis sentence pair input from the existing rule set, and by performing the OOD detection based on this rule detection model 11, the premise-hypothesis sentence pairs that do not conform to the existing rule set may be accurately selected from the base dataset of the natural language inference task. Furthermore, the new rule set that encompasses the diversity of the premise-hypothesis sentence pair not covered by the existing rule set may be accurately derived through the premise-hypothesis sentence pair selected in this way, and as a result, a high-quality augmented dataset for the natural language inference task may be easily and automatically generated.

In addition, the OOD score may be accurately calculated based on the maximum probability value output by the rule detection model 11, the corrected probability distribution according to the value of the temperature parameter, the adjusted probability distribution according to perturbation, or the like, and as a result, the premise-hypothesis sentence pairs that do not conform to the existing rule set in the base dataset may be more accurately selected.

Additionally, by performing cluster-based filtering based on the cohesion and label inconsistency, the premise-hypothesis sentence pairs that do not conform to the existing rule set in the base dataset may be more accurately selected.

Furthermore, by applying the new rules to the generative language models, the hypothesis sentence corresponding to the original premise sentence may be accurately generated, and as a result, the high-quality augmented dataset for the natural language inference task may be more easily automatically generated.

Below, the results of performance experiments conducted by the inventors of the present disclosure are briefly described.

The present inventors conducted an experiment to verify the performance of the above-described method (hereinafter, referred to as the “proposed method”) for deriving the novel rule.

Specifically, the inventors of the present disclosure performed the OOD detection based on the rule detection model (for example, 11) and conducted an experiment to select premise-hypothesis sentence pairs that did not conform to 15 existing rules in the Stanford Natural Language Inference (SNLI) dataset, which consists of a total of 550,152 premise-hypothesis sentence pairs. The inventors automatically generated the training set by applying the 15 existing rules to 15,000 original premise sentences extracted from the SNLI dataset, and fine-tuned the BERT-base model using this set to construct the rule detection model (for example, 11). Please refer to Table 1 below for the 15 existing rules.

TABLE 1

| Label | Existing rule | Explanation | Example |
|---|---|---|---|
| Entailment | HS | Substitute noun of | Dog -> Animal |
| | (Hypernym | premise sentence with | |
| | Substitution) | hypernym | |
| | PS | Substitute noun of | Two men -> |
| | (Pronoun | premise sentence with | They |
| | Substitution) | pronoun | |
| | COUNT | Count number of nouns | A bike and a |
| | (Counting) | with common hypernym | car -> Two |
| | | in premise sentence | automobiles |
| | | and replace nouns | |
| | | with hypernym | |
| | PA | Paraphrase specific | Bench -> Seat |
| | (Paraphrasing) | word/phrase from | |
| | | premise sentence | |
| | ES (Extracting | Extract core meaning | A person with |
| | Snippets) | of specific phrase | red shirt -> |
| | | in premise sentence | A person |
| Contradic- | CW_adj | Substitute adjective | Big -> Small |
| tion | (Contradictory | in premise sentence | |
| | Word | with contradictory | |
| | adjective) | word | |
| | CW_noun | Substitute noun in | Piano -> |
| | (Contradictory | premise sentence with | Violin |
| | Word noun) | contradictory word | |
| | CV | Substitute verb in | Walk -> Drive |
| | (Contradictory | premise sentence with | |
| | Verb) | contradictory word | |
| | NS (Number | Change number of | Two -> Seven |
| | Substitution) | premise sentences | |
| | SOS (Subject | Swap positions of | (Clock, |
| | Object Swap) | subject and object in | Pillow) -> |
| | | premise sentence | (Pillow, |
| | | | Clock) |
| | IH (Irrelevant | Sample sentence | — |
| | Hypothesis) | completely irrelevant | |
| | | to premise sentence | |
| | NI (Negation | Introduce negation to | Cover -> |
| | Introduction) | premise sentence | Not Cover |
| Neutral | AM (Adding | Add modifier to | Bird -> |
| | Modifiers) | premise sentence | Small bird |
| | CON | Add position and | Eating the |
| | (ConceptNet) | relationship | grass -> |
| | | information, etc. to | Eating the |
| | | premise sentence | grass in the |
| | | | yard |
| | SSNCV (Same | Change verb in | Sleeping -> |
| | Subject but | premise sentence to | Laying + Chair |
| | Non- | synonym/analogue and | |
| | Contradictory | add arbitrary noun | |
| | Verb) | | |

Next, the inventors randomly selected 500 premise-hypothesis sentence pairs from the SNLI dataset and performed the OOD detection based on the rule detection model on these pairs to select the premise-hypothesis sentence pairs that did not conform to existing rules (that is, the premise-hypothesis sentence pairs were selected without applying a clustering technique to verify the performance of the OOD detection). The inventors calculated the OOD scores based on a combination of the methods illustrated in FIGS. 6 to 9, and examples of OOD detection results are provided in Table 2 below.

TABLE 2

| | Existing rule | OOD detection |
|---|---|---|
| Sentence pair | (correct answer) | result |
| Premise: Girls walk down | PA | ID |
| the street Hypothesis: The | | |
| girls set down in the | | |
| street | | |
| Premise: A young man in a | — | OOD |
| heavy brown winter coat | | |
| stands in front of a blue | | |
| railing with his arms | | |
| spread Hypothesis: The | | |
| young man is at his | | |
| grandmother's house | | |

As illustrated in Table 2, the inventors confirmed that the proposed method (or OOD detection based on the rule detection model) may detect the premise-hypothesis sentence pairs that do not conform to 15 existing rules in the SNLI dataset with a fairly high accuracy.

Table 3 below lists four new rules derived by the inventors by analyzing the premise-hypothesis sentence pairs selected through the proposed method.

TABLE 3

| Label | Existing rule | Explanation |
|---|---|---|
| Entailment | RG (Role | Substitute specific role or |
| | Generalization) | occupation with more general |
| | | expression in premise sentence |
| Neutral | CA (Contextual | Add purpose or background |
| | Augmentation) | information not stated in |
| | | premise sentence |
| | VS (Visual | Add expressions about visual |
| | Specification) | characteristics (for example, |
| | | design, state, etc.) not |
| | | specified in premise sentence |
| | EI (Emotion | Infer emotion or state based on |
| | Inference) | behavior shown in premise |
| | | sentence and add phrase |
| | | corresponding to inferred result |

The results of performance experiments conducted by the inventors of the present disclosure have been briefly described. Below, with reference to FIG. 12, an exemplary computing device 120 capable of implementing the above-described system 10 will be described.

FIG. 12 is an exemplary hardware configuration diagram illustrating the computing device 120.

As illustrated in FIG. 12, the computing device 120 may include one or more processors 121, a bus 123, a communication interface 124, a memory 122 for loading a computer program 126 executed by the processor 121, and a storage 125 for storing the computer program 126. However, only components related to the embodiment of the present disclosure are illustrated in FIG. 12. Therefore, a person skilled in the art to which the present disclosure pertains will appreciate that other general components may be included in addition to the components 121 to 126 illustrated in FIG. 12. That is, the computing device 120 may further include various components in addition to the components 121 to 126 illustrated in FIG. 12. In addition, in some cases, the computing device 120 may be configured in a form in which some of the components 121 to 126 illustrated in FIG. 12 are omitted. Below, each component of the computing device 120 is described.

The processor 121 may control the overall operation of each component of the computing device 120. The processor 121 may be configured to include at least one of a central processing unit (CPU), a micro processor unit (MPU), a micro controller unit (MCU), a graphics processing unit (GPU), a tensor processing unit (TPU), a neural processing unit (NPU), or any other type of processor well known in the art of the present disclosure. In addition, the processor 121 may perform operations on at least one application or program to execute specific steps/operations/methods. The computing device 120 may include one or more processors.

Next, the memory 122 may store various data, commands, and/or information. The memory 122 may load the computer program 126 from the storage to 125 execute specific steps/operations/methods. The memory 122 may be implemented as a volatile memory such as RAM, but the technical scope of the present disclosure is not limited thereto.

Next, the bus 123 may provide a communication function between components of the computing device 120. The bus 123 may be implemented as various types of buses, such as an address bus, a data bus, and a control bus.

Next, the communication interface 124 may support wired and wireless Internet communication of the computing device 120. Furthermore, the communication interface 124 may also support various communication methods other than Internet communication. To this end, the communication interface 124 may be configured to include a communication module well known in the technical field of the present disclosure.

Next, the storage 125 may non-temporarily store one or more computer programs 126. The storage 125 may be configured to include non-volatile memory such as read only memory (ROM), erasable programmable ROM (EPROM), electrically erasable programmable ROM (EEPROM), flash memory, a hard disk, a removable disk, or any form of computer-readable recording medium well known in the art to which the present disclosure pertains.

Next, the computer program 126 may include instructions that cause the processor 121 to perform specific steps/operations/methods when loaded into the memory 122. That is, the processor 121 perform specific may steps/operations/methods by executing the instructions loaded into the memory 122.

For example, the computer program 126 may include instructions for an operation of obtaining the base dataset for the natural language inference task, an operation of obtaining the rule detection model 11 that detects the existing rule conforming to the premise-hypothesis sentence pair input from the existing rule set, and an operation of selecting the plurality of premise-hypothesis sentence pairs that does not conform to the existing rule set from the base dataset by performing the OOD detection based on the rule detection model 11 on the base dataset.

As another example, the computer program 126 may include instructions to perform at least some of the steps/operations/methods described with reference to FIGS. 1 to 11.

In the case illustrated, the system 10 according to some embodiments of the present disclosure may be implemented via the computing device 120.

Meanwhile, in some embodiments, the computing device 120 illustrated in FIG. 12 may refer to a virtual machine implemented based on cloud technology. For example, the computing device 120 may be a virtual machine operating on one or more physical servers included in a server farm. In this case, at least some of the processor 121, the memory 122, and the storage 125 illustrated in FIG. 12 may be virtual hardware, and the communication interface 124 may also be implemented as a virtualized networking element, such as a virtual switch.

So far, the exemplary computing device 120 capable of implementing a system 10 according to some embodiments of the present disclosure has been described with reference to FIG. 12.

Various embodiments of the present disclosure and effects according to the embodiments have been described with reference to FIGS. 1 through 12. The effects according to the technical concept of the present disclosure are not limited to the effects described above, and other effects not mentioned will be clearly understood by those skilled in the art from the description below.

Furthermore, even though the above embodiments have described multiple components as being combined or operating in combination, the technical concept of the present disclosure is not necessarily limited to these embodiments. That is, within the scope of the technical concept of the present disclosure, all of the components may be selectively combined and operated one or more times.

The technical concepts of the present disclosure described so far may be implemented as computer-readable code on a computer-readable recording medium. A computer program stored on the computer-readable recording medium may be transmitted to another computing device via a network such as the Internet, installed on the device, and used therein.

Although the operations are depicted in a specific order in the drawings, it should not be understood that the operations must be performed in the specific order depicted, or in a sequential order, or that all depicted operations must be performed to achieve the desired result. In certain circumstances, multitasking and parallel processing may be advantageous. Although various embodiments of the present disclosure have been described above with reference to the attached drawings, those skilled in the art to which the present disclosure pertains will understand that the technical concepts of the present disclosure can be implemented in other specific forms without changing the technical concepts or essential characteristics thereof. Therefore, it should be understood that the embodiments described above are illustrative in all respects and not restrictive. The scope of protection of the present disclosure should be interpreted by the claims below, and all technical ideas within a scope equivalent thereto should be interpreted as being included in the scope of the technical ideas defined by the present disclosure.

What is claimed is:

1. A method for deriving a new rule for data augmentation in a natural language inference task and performed by at least one processor, the method comprising:
acquiring a base dataset for a natural language inference task, the base dataset including sentence pairs composed of a premise sentence and a hypothesis sentence, and a label assigned to each of the sentence pairs, the label representing a class according to a logical relationship between the premise sentence and the hypothesis sentence;
acquiring a rule detection model that detects an existing rule conforming to a premise-hypothesis sentence pair input from an existing rule set, the existing rule set including one or more existing rules that transform a given premise sentence into a hypothesis sentence; and
selecting a plurality of premise-hypothesis sentence pairs that does not conform to the existing rule set from the base dataset by performing out-of-distribution (OOD) detection based on the rule detection model on the base dataset,
wherein the selected premise-hypothesis sentence pairs are used to derive a new rule set for generating an augmented dataset for the natural language inference task.

2. The method according to claim 1, wherein the base dataset belongs to a source domain,
the augmented dataset belongs to a target domain, and
the target domain is a domain with a smaller amount of natural language inference datasets than the source domain.

3. The method according to claim 1, wherein the rule detection model is constructed by fine-tuning a pretrained language model using a task of detecting the existing rule.

4. The method according to claim 1, wherein a training process of the rule detection model includes
obtaining a plurality of original premise sentences,
generating hypothesis sentences corresponding to the plurality of original premise sentences using the existing rule set and setting the existing rule used in the generation process as a label to generate a training set, and
training the rule detection model by performing a task of detecting the existing rules using the training set.

5. The method according to claim 1, wherein the rule detection model is configured to output a probability distribution for the existing rule set,
the selecting of the plurality of premise-hypothesis sentence pairs includes
selecting a specific premise-hypothesis sentence pair from the base dataset,
calculating an OOD score for the specific premise-hypothesis sentence pair based on output of the rule detection model for the specific premise-hypothesis sentence pair, and
determining the specific premise-hypothesis sentence pair as the sentence pair that does not conform to the existing rule set when the OOD score is equal to or less than a threshold.

6. The method according to claim 5, wherein the OOD score is calculated based on a maximum probability value output by the rule detection model.

7. The method according to claim 5, wherein the probability distribution is calculated by applying a softmax operation to a raw output value of the rule detection model, and
the calculating of the OOD score includes
correcting the probability distribution by adjusting a scale of the raw output value according to a preset temperature parameter value, and
calculating the OOD score based on the corrected probability distribution.

8. The method according to claim 5, wherein the calculating of the OOD score includes
applying perturbation to increase a maximum probability value of the rule detection model to a value associated with the specific premise-hypothesis sentence pair, and
calculating the OOD score based on an output probability distribution of the rule detection model to which the perturbation is applied.

9. The method according to claim 8, wherein the rule detection model is configured to receive an embedding vector of each token included in the premise-hypothesis sentence pair, and
the perturbation is applied to at least some of the embedding vectors of a plurality of tokens included in the specific premise-hypothesis sentence pair.

10. The method according to claim 1, wherein the selecting of the plurality of premise-hypothesis sentence pairs includes
selecting candidate premise-hypothesis sentence pairs that do not conform to the existing rule set from the base dataset through the OOD detection,
constructing a plurality of clusters through clustering of the candidate premise-hypothesis sentence pairs, and
excluding some clusters of the plurality of clusters according to a preset filtering criterion to select the plurality of premise-hypothesis sentence pairs.

11. The method according to claim 10, wherein the excluding of some clusters includes
calculating a cohesion of each of the plurality of clusters, and
excluding clusters among the plurality of clusters whose cohesion is less than a threshold.

12. The method according to claim 11, wherein the excluding of some clusters includes
calculating inconsistency of the label in each of the plurality of clusters, and
excluding clusters among the plurality of clusters whose inconsistency is equal to or more than the threshold.

13. The method according to claim 1, further comprising:
acquiring the new rule set and a plurality of original premise sentences; and
applying the new rule set to a generative language model to generate hypothesis sentences corresponding to the plurality of original premise sentences, thereby generating the augmented dataset.

14. A system for deriving a new rule for data augmentation in a natural language inference task, the system comprising:
one or more processors; and
a memory storing a computer program executed by the one or more processors,
wherein the computer program includes instructions for
an operation of acquiring a base dataset for a natural language inference task, the base dataset including sentence pairs composed of a premise sentence and a hypothesis sentence, and a label assigned to each of the sentence pairs, the label representing a class according to a logical relationship between the premise sentence and the hypothesis sentence,
an operation of acquiring a rule detection model that detects an existing rule conforming to a premise-hypothesis sentence pair input from an existing rule set, the existing rule set including one or more existing rules that transform a given premise sentence into a hypothesis sentence, and
an operation of selecting a plurality of premise-hypothesis sentence pairs that does not conform to the existing rule set from the base dataset by performing out-of-distribution (OOD) detection based on the rule detection model on the base dataset, and
the selected premise-hypothesis sentence pairs are used to derive a new rule set for generating an augmented dataset for the natural language inference task.

15. The system according to claim 14, wherein the rule detection model is configured to output a probability distribution for the existing rule set, and
the operation of selecting the plurality of premise-hypothesis sentence pairs includes
an operation of selecting a specific premise-hypothesis sentence pair from the base dataset,
an operation of calculating an OOD score for the specific premise-hypothesis sentence pair based on output of the rule detection model for the specific premise-hypothesis sentence pair, and
an operation of determining the specific premise-hypothesis sentence pair as the sentence pair that does not conform to the existing rule set when the OOD score is equal to or less than a threshold.

16. The system according to claim 14, wherein the operation of selecting the plurality of premise-hypothesis sentence pairs includes
an operation of selecting candidate premise-hypothesis sentence pairs that do not conform to the existing rule set from the base dataset through the OOD detection,
an operation of constructing a plurality of clusters through clustering of the candidate premise-hypothesis sentence pairs, and
an operation of excluding some clusters of the plurality of clusters according to a preset filtering criterion to select the plurality of premise-hypothesis sentence pairs.

17. A computer program combined with a processor of a computer and stored in a computer-readable recording medium to execute:
acquiring a base dataset for a natural language inference task, the base dataset including sentence pairs composed of a premise sentence and a hypothesis sentence, and a label assigned to each of the sentence pairs, the label representing a class according to a logical relationship between the premise sentence and the hypothesis sentence;
acquiring a rule detection model that detects an existing rule conforming to a premise-hypothesis sentence pair input from an existing rule set, the existing rule set including one or more existing rules that transform a given premise sentence into a hypothesis sentence; and
selecting a plurality of premise-hypothesis sentence pairs that does not conform to the existing rule set from the base dataset by performing out-of-distribution (OOD) detection based on the rule detection model on the base dataset,
wherein the selected premise-hypothesis sentence pairs are used to derive a new rule set for generating an augmented dataset for the natural language inference task.
